(19) United States
(12) Patent Application Publication
(10) Pub. No.: US 2025/0313701 A1
(43) Pub. Date: Oct. 9, 2025

(54) METHOD FOR PREPARING BIODEGRADABLE POLYMER EMULSION, BIODEGRADABLE POLYMER EMULSION PREPARED THEREBY, AND BIODEGRADABLE POLYMER COATING SOLUTION USING SAME

(71) Applicant: LOTTE FINE CHEMICAL CO., LTD., Ulsan (KR)

(72) Inventors: Joonsoo Lee, Ulsan (KR); Dooho Kim, Ulsan (KR); Gyungdon Kang, Ulsan (KR); Gyujong Jeon, Ulsan (KR); Sangeun Shin, Ulsan (KR)

(73) Assignee: LOTTE FINE CHEMICAL CO., LTD., Ulsan (KR)

(21) Appl. No.: 18/862,309

(22) PCT Filed: Dec. 21, 2023
(86) PCT No.: PCT/KR2023/021300

§ 371 Date: Nov. 1, 2024

(30) Foreign Application Priority Data
Dec. 27, 2022 (KR) 10-2022-0186403
May 25, 2023 (KR) 10-2023-0067874

(51) Int. Cl. C09D 5/02; C09D 7/45; C09D 7/65; C09D 7/80; C09D 167/02; C09D 167/04

(52) U.S. Cl. CPC C09D 5/027; C09D 5/022; C09D 7/45; C09D 7/65; C09D 7/80; C09D 167/02; C09D 167/04

(57) ABSTRACT

The present invention relates to a biodegradable polymer emulsion and a biodegradable polymer coating solution using same and, more specifically, to: a method for preparing a biodegradable polymer emulsion, in which a water-dispersion-type biodegradable polymer emulsion is prepared by uniformly dispersing a biodegradable polymer in water by using hydroxyethyl cellulose based on natural materials, without using an organic solvent, and thus no organic waste liquid is generated in the preparation process, thus being environmentally friendly, toxicity due to residual organic solvent or emulsifier or deterioration in the physical properties of the biodegradable polymer can be prevented, and the intrinsic physical properties of the biodegradable polymer, such as water resistance, can be maintained or improved; a biodegradable polymer emulsion prepared thereby; and a biodegradable polymer coating solution using same.

### TECHNICAL FIELD

The present disclosure relates to a biodegradable polymer emulsion and a biodegradable polymer coating solution using the same. More particularly, the present disclosure relates to a method of preparing a biodegradable polymer emulsion, which enables an environmentally friendly biodegradable polymer emulsion to be prepared by a simple method that does not deteriorate the physical properties of the biodegradable polymer without involving the use of a highly toxic organic solvent or emulsifier, to a biodegradable polymer emulsion prepared thereby, and to a biodegradable polymer coating solution using the same.

### BACKGROUND ART

Products made from polymeric materials such as polyethylene, polypropylene, and polystyrene, commonly used in daily life, are used in a wide range of applications. In addition, disposable packaging materials, industrial materials, and the like cannot be used multiple times, and the consumption of products for short-term use tends to increase daily, causing serious environmental problems with disposal after use.

Although products made from polyolefin-based resins are currently recyclable after use, there are only a limited number of applications for recycling such products, ultimately leading to the disposal of polymers. For this reason, there is a demand for a further fundamental solution. In addition, incineration of polyolefin-based resins for disposal produces toxic gases, and when buried, the environment is adversely affected because the landfill is not biodegradable.

Various technologies regarding biodegradable polymers are currently being proposed as alternatives to solve such problems. Biodegradable polymers can be broadly categorized into natural polymers (starch, rubber, and the like), copolymerized polymers (poly-hydroxy alkanoate and the like), and synthetic polymers [aliphatic polyester, polycaprolactone (PCL), polylactic acid (PLA), polybutylene adipate terephthalate (PBAT), and the like]. In particular, synthetic polymers that can be produced in large quantities are widely used.

Due to the miscibility, dispersibility, storage stability, and the like, these biodegradable polymers typically are dissolved in organic solvents, then emulsified with lipophilic or hydrophilic emulsifiers, and used in emulsion form. For example, Non-Patent Document 1 and Patent Document 1 have disclosed methods for preparing biodegradable water-repellent emulsion compositions by dissolving a biodegradable polymer in an organic solvent, such as highly toxic methylene chloride or chloroform, and then preparing an emulsion using a lipophilic emulsifier, such as oleic acid or dimethylamine, or a hydrophilic emulsifier such as triethanolamine.

However, the abovementioned methods involve the use of highly toxic organic solvents and emulsifiers when preparing the emulsion, so the process is harmful. Even when such organic solvents and emulsifiers are removed from the preparation process, some organic solvent or emulsifier components may remain, which has been problematic.

In addition, Patent Document 2 has disclosed a method for preparing a biodegradable polyester dispersion solution by dispersing biodegradable polyester using an aqueous emulsifier such as polyvinyl alcohol (PVA) to prepare an emulsion. However, the biodegradable polymer emulsion prepared by the abovementioned method has poor water resistance, making the use thereof in coating and packaging, requiring water resistance, limited.

Accordingly, there is a need for research and development on environmentally friendly biodegradable polymer emulsions, which enable biodegradable polymers to be uniformly dispersed by a simple method that does not deteriorate the physical properties of the biodegradable polymers without involving the use of highly toxic organic solvents or emulsifiers.

### DOCUMENT OF RELATED ART

### Patent Document

(Patent Document 0001) Korean Patent No. 1346308 (Publication date: 2013 Aug. 7.)
(Patent Document 0002) U.S. Pat. No. 6,716,911 (Publication date: 2003 Sep. 25.)

### Non-Patent Document

(Non-Patent Document 1) Min-Hyung Lee et al., Journal of Korea TAPPI, Vol. 44. No. 6, 2012, 28-35

### DISCLOSURE

### Technical Problem

The present disclosure, which has been primarily made to solve the abovementioned problems, aims to provide a method of preparing an environmentally friendly biodegradable polymer emulsion, which a biodegradable polymer to be enables uniformly dispersed in a predetermined size by a simple method that does not deteriorate the physical properties of the biodegradable polymer without involving the use of a highly toxic organic solvent or emulsifier, and to provide an environmentally friendly biodegradable polymer emulsion prepared thereby.

Furthermore, the present disclosure aims to provide a biodegradable polymer coating solution using the abovementioned environmentally friendly biodegradable polymer emulsion.

### Technical Solution

To accomplish the abovementioned objectives, one embodiment of the present disclosure provides a method of preparing a biodegradable polymer emulsion, the method including the following steps: (a) mixing a biodegradable polymer, hydroxyethyl cellulose, and water to obtain a mixture; (b) heating the resulting mixture to a temperature in the range of the melting point of the biodegradable polymer or higher to the boiling point of water or lower, with stirring; and (c) cooling the heated and stirred mixture.

In the preferred embodiment of the present disclosure, the biodegradable polymer may be characterized by being a biodegradable polymer having a melting point that is equal to or lower than the boiling point of water.

In the preferred embodiment of the present disclosure, the biodegradable polymer may be one or more selected from the group consisting of polybutylene adipate terephthalate (PBAT), polybutylene adipate (PBA), polybutylene succinate-adipate (PBSA), polybutylene succinate-terephthalate (PBST), polycaprolactone (PCL), and polyethylene adipate (PEA).

In the preferred embodiment of the present disclosure, the hydroxyethyl cellulose (HEC) may be hydrophobically modified hydroxyethyl cellulose (HMHEC).

In the preferred embodiment of the present disclosure, Step (a) may be characterized in that 1.0 to 20 parts by weight of hydroxyethyl cellulose and 60 to 500 parts by weight of water, with respect to 100 parts by weight of the biodegradable polymer, are mixed.

Another embodiment of the present disclosure provides a biodegradable polymer emulsion characterized by including: a biodegradable polymer; 2.5 to 20 parts by weight of hydroxyethyl cellulose with respect to 100 parts by weight of the biodegradable polymer; and 100 to 500 parts by weight of water with respect to 100 parts by weight of the biodegradable polymer, wherein the biodegradable polymer has an average particle diameter in the range of 5 μm to 100 μm.

In the preferred embodiment of the present disclosure, the biodegradable polymer may be characterized by being a biodegradable polymer having a melting point that is equal to or lower than the boiling point of water.

In the preferred embodiment of the present disclosure, the biodegradable polymer may be characterized by being one or more selected from the group consisting of polybutylene adipate terephthalate (PBAT), polybutylene adipate (PBA), polybutylene succinate-adipate (PBSA), polybutylene succinate-terephthalate (PBST), polycaprolactone (PCL), and polyethylene adipate (PEA).

In the preferred embodiment of the present disclosure, the hydroxyethyl cellulose (HEC) may be characterized by being hydrophobically modified hydroxyethyl cellulose (HMHEC).

A further embodiment of the present disclosure provides a biodegradable polymer coating solution using a biodegradable polymer emulsion including: a biodegradable polymer; 2.5 to 20 parts by weight of hydroxyethyl cellulose with respect to 100 parts by weight of the biodegradable polymer; and 100 to 500 parts by weight of water with respect to 100 parts by weight of the biodegradable polymer, wherein the biodegradable polymer has an average particle diameter in the range of 5 μm to 100 μm.

### Advantageous Effects

According to the present disclosure, a water-dispersion type biodegradable polymer emulsion is prepared by uniformly dispersing a biodegradable polymer in water using hydroxyethyl cellulose based on natural materials without involving the use of an organic solvent, meaning that no organic waste liquid is generated in the preparation process, or no residual toxic organic solvent is contained in the polymer while hydroxyethyl cellulose based on natural materials is used as an emulsifier, thus being environmentally friendly.

In addition, the biodegradable polymer emulsion and a biodegradable polymer coating solution using the same, according to the present disclosure, can prevent deterioration in the physical properties of the polymer. In addition, when coating the surface of a material requiring control of release amount with the abovementioned emulsion, a uniform coating film can be formed on the surface of the material, and the material can be gradually released in an aqueous solution by maintaining or improving the water resistance of the coating film formed, so there is a significant effect of controlling the release rate.

### DESCRIPTION OF DRAWINGS

FIG. 1 is a schematic process diagram of a biodegradable polymer emulsion according to one embodiment of the present disclosure;

FIG. 2 is a photographic image of a biodegradable polymer emulsion prepared in Example 5, the photographic image taken with a digital camera;

FIG. 3 is a photographic image of a biodegradable polymer emulsion prepared in Example 5, the photographic image taken with a scanning electron microscope (SEM);

FIG. 4 is a photographic image for evaluating the water resistance of a coating formed using a biodegradable polymer emulsion of Comparative Example 5, the photographic image taken with a digital camera;

FIG. 5 is a photographic image for evaluating the water resistance of a coating formed using a biodegradable polymer emulsion of Example 2, the photographic image taken with a digital camera;

FIG. 6 is a photographic image for evaluating the water resistance of a coating formed using a biodegradable polymer emulsion of Example 7, the photographic image taken with a digital camera; and

FIG. 7 shows photographic images of fertilizers coated with a biodegradable polymer emulsion prepared in Example 9, the photographic images taken with a digital camera, in which FIGS. 7A, 7B, 7C, and 7D show the fertilizers immediately after coating, 5 days later, 15 days later, and 30 days later, respectively.

### MODE FOR INVENTION

Advantages and features of the present disclosure, and methods for achieving those will become clear with reference embodiments described in detail in to the following conjunction with the accompanying drawings. However, the present disclosure is not limited to the embodiments set forth below and will be implemented in many different forms. The following embodiments are provided only to completely disclose the present disclosure and inform those skilled in the art of the scope of the present disclosure. In addition, the present disclosure is defined only by the scope of the appended claims.

In the following description of the present disclosure, when it is determined that the detailed description of the known art related to the present disclosure might obscure the gist of the present disclosure, the detailed description thereof will be omitted.

As mentioned herein, the terms such as “including”, “having”, and “comprising” used are generally intended to allow other parts to be added unless these terms are used with “only”. Any references to singular may include plural unless expressly stated otherwise.

Features of various embodiments of the present disclosure may be partially or overall coupled to or combined with each other, and may be variously inter-operated with each other and driven. The embodiments of the present disclosure may be carried out independently from each other or may be carried out together in a co-dependent relationship.

In one aspect, the present disclosure relates to a method of preparing a biodegradable polymer emulsion, the method being characterized by including the following steps: (a) mixing a biodegradable polymer, hydroxyethyl cellulose, and water to obtain a mixture; (b) heating the resulting mixture to a temperature in the range of the melting point of the biodegradable polymer or higher to the boiling point of water or lower, with stirring; and (c) cooling the heated and stirred mixture.

Additionally, in another aspect, the present disclosure relates to a biodegradable polymer emulsion characterized by including: a biodegradable polymer; 1.0 to 20 parts by weight of hydroxyethyl cellulose with respect to 100 parts by weight of the biodegradable polymer; and 60 to 500 parts by weight of water with respect to 100 parts by weight of the biodegradable polymer, wherein the biodegradable polymer has an average particle diameter in the range of 5 μm to 100 μm, and to a biodegradable polymer coating solution using the same.

According to the present disclosure, the biodegradable resin and hydroxyethyl cellulose based on natural materials are used, so both materials used are characterized by being biodegradable and environmentally friendly. Additionally, no residual toxic organic solvent is contained in the polymer because no organic solvent is used, the water resistance does not deteriorate even after emulsification, and the inherent water resistance of the original biodegradable polymer may be maintained.

The description of each of the components will be described in the method of preparing the biodegradable polymer emulsion to avoid duplication.

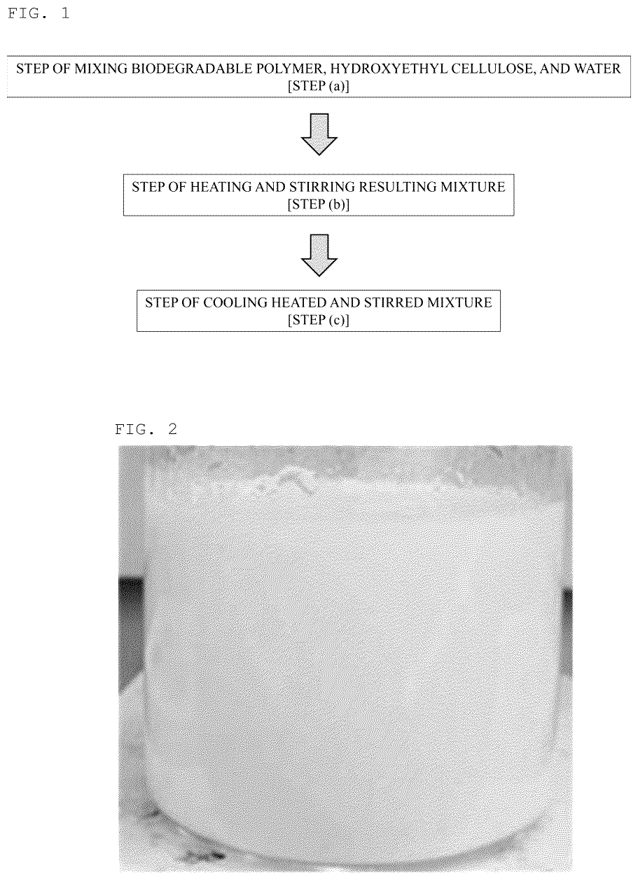

FIG. 1 is a schematic process diagram of the biodegradable polymer emulsion according to one embodiment of the present disclosure.

Referring to FIG. 1, in order to prepare the biodegradable polymer emulsion according to one embodiment of the present disclosure, the biodegradable polymer, hydroxyethyl cellulose, and water are first mixed to obtain a mixture [Step (a)].

Any polymers biodegradable without any help in vivo or in the external environment in response to various environmental factors such as moisture, microorganisms, temperature, and the like may be used without particular limitation as the biodegradable polymer, which may, for example, be polybutylene adipate terephthalate (PBAT), polybutylene adipate (PBA), polybutylene succinate-adipate (PBSA), polybutylene succinate-terephthalate (PBST), polycaprolactone (PCL), or polyethylene adipate (PEA). In particular, a biodegradable polymer having a melting point that is equal to or lower than the boiling point of water may be dissolved at temperatures of the boiling point of water or lower and emulsified, so the use thereof is preferable. In terms of a Biodegradable polymer having a melting point higher than the boiling point of water, a separate high-pressure device is required to be used to enable the emulsification of the biodegradable polymer according to the melting point thereof.

This hydroxyethyl cellulose (HEC) is a cellulose derivative in which hydroxy groups in cellulose are and not only hydroxyethyl substituted with ethyl groups, cellulose (HEC) but also hydrophobically modified hydroxyethyl cellulose (HMHEC) may be used.

A currently available product or product prepared may be used as the hydroxyethyl cellulose, and any preparation methods known in the art may be applicable as methods of preparing the hydroxyethyl cellulose without limitation. Preferably, the hydroxyethyl cellulose is prepared by reacting cellulose with an alkalizing obtain alkalized cellulose and then reacting the resulting alkalized cellulose through an etherification reaction.

In this case, the hydroxyethyl cellulose may be mixed in the amount range of 1.0 to 20 parts by weight with respect to 100 parts by weight of the biodegradable polymer. When the hydroxyethyl cellulose is mixed in an amount of less than 1.0 part by weight, the emulsion may fail to be effectively formed. When the hydroxyethyl cellulose is mixed in an amount exceeding 20 parts by weight, an increase in excessive amounts of water-soluble polymers may lead to deterioration in the water resistance of a coating film.

The water in which the biodegradable polymer and the hydroxyethyl cellulose are mixed serves as a dispersion medium in which the hydroxyethyl cellulose and the biodegradable polymer are dispersed and is not particularly limited in type, which may be deionized water, pure water, ultrapure water, distilled water, or the like.

In this case, the water may be mixed in the amount range of 60 to 500 parts by weight with respect to 100 parts by weight of the biodegradable polymer. When the amount of the water with respect to the biodegradable polymer falls within the above range, the biodegradable polymer may be uniformly dispersed in water-dispersion form without causing deterioration in the water resistance of the biodegradable polymer. Additionally, the viscosity and solid content of the emulsion may be controlled by adjusting the amount of the water added.

The mixing method of the biodegradable polymer, the hydroxyethyl cellulose, and the water may be performed regardless of any particular order and method of addition. For example, the biodegradable polymer and the hydroxyethyl cellulose may be added to the water all at once and mixed. Alternatively, either the biodegradable polymer or hydroxyethyl cellulose may be added to the water, followed by adding and mixing unadded hydroxyethyl cellulose or biodegradable polymer. Alternatively, the biodegradable polymer may be added to the hydroxyethyl cellulose, followed by adding and mixing the water.

However, in order to facilitate each of the abovementioned components to be mixed, it is preferable to uniformly mix the hydroxyethyl cellulose in the water to form a hydroxyethyl cellulose aqueous solution, and then add the biodegradable polymer to the hydroxyethyl cellulose aqueous solution formed. In this case, the biodegradable polymer may be mixed after preheating the hydroxyethyl cellulose aqueous solution to a temperature in the range of the melting point of the biodegradable polymer or higher to the boiling point of water or lower. When the melting point of the biodegradable polymer added exceeds 100° C., the water may be pressurized to increase the boiling point, or the biodegradable polymer may be heated to a temperature of the melting point and then mixed in the hydroxyethyl cellulose aqueous solution.

The mixture in which the water, the hydroxyethyl cellulose, and the biodegradable polymer are mixed in such a manner is then heated to a temperature in the range of the melting point of the biodegradable polymer mixed or higher to the boiling point of water or lower, with stirring [Step (b)].

When the temperature to which the mixture is heated is lower than the melting point of the biodegradable polymer added, there may be a problem in that the biodegradable polymer may fail to be melted while being stuck together, forming a large lump, or the emulsion may fail to be formed while not being melted.

In addition, the stirring may be performed using a commonly used stirrer, mixer, or the like, in which the stirring speed and stirring time may also fall within commonly used ranges. For example, the stirring may be performed at a high speed in the range of 1000 rpm to 10,000 rpm for 5 minutes to 60 minutes.

Subsequently, when the resulting mixture is emulsified, the stirred mixture is cooled [Step (c)].

The cooling may be performed by a commonly used cooling device or method, and the temperature to which the resulting mixture is cooled may be equal to or lower than the melting point of the biodegradable polymer mixed.

In addition, the biodegradable polymer emulsion, according to the present disclosure, may be mixed by further adding an additive, as needed, after Step (a) and/or before or after Step (c).

Preferably, examples of the additive include an interfacial stabilizer, storage stabilizer, and the like, commonly used in the art, and the present disclosure is not particularly limited in terms of selecting such additives.

Such an additive may be selected in any amount commonly used within a range that does not impair the intended physical properties of the degradable polymer emulsion of the present disclosure without limitation. However, with respect to 100 parts by weight of the biodegradable polymer emulsion of the present disclosure, each additive may be independently added in the amount range of 0.1 to 2 parts by weight, which is preferable.

In the biodegradable polymer emulsion according to the present disclosure, prepared in such a manner, and the biodegradable polymer coating solution using the same, the biodegradable polymer dispersed may have an average diameter in the range of 5 μm to 100 μm, which is more preferably in the range of 7 μm to 25 μm. When the average particle diameter of the biodegradable polymer dispersed falls within the above range, emulsion particles are stable without causing precipitation and have good flowability, which is effective in being easily applicable and also effective in forming a uniform coating film.

Hereinafter, the present disclosure will be described in more detail through the following specific examples. However, the following examples are only to help the understanding of the present disclosure, and the scope of the present disclosure is not limited thereto.

### Example 1

Into a 1.5 L Jacket reactor filled with 140 ml of pure water, 10 g of hydroxyethyl cellulose (HEC) was introduced. Then, the resulting product was stirred at a speed of 300 rpm for one hour to prepare a clear hydroxyethyl cellulose aqueous solution. Such a prepared hydroxyethyl cellulose aqueous solution was heated to a temperature of 80° C., and 100 g of a biodegradable polymer was then gradually introduced into the heated hydroxyethyl cellulose aqueous solution. The mixture into which the biodegradable polymer was introduced was heated to a temperature of 80° C. for 30 minutes with stirring at a high speed of 3,000 rpm to perform emulsification. Then, the emulsified mixture was slowly stirred at a speed of 1,000 rpm and cooled at the same time, thereby preparing a biodegradable polymer emulsion in which the biodegradable polymer had an average particle diameter of 8 μm.

### Examples 2 to 12 and Comparative Examples 1 to 5

Biodegradable polymer emulsions were prepared in the same manner as in Example 1, except for using varying components and amounts under conditions shown in Table 1 below. In this case, the manufacturer, product name, and the like of each component used in the examples and comparative examples are shown in Table 2.

TABLE 1

| | | Biodegradable polymer | | | | | |
|---|---|---|---|---|---|---|---|
| | | | Melting | | Emulsifier | | Water |
| | Emulsification | | point | Amount | | Amount | Amount |
| Classification | temperature | Type | (° C.) | (g) | Type | (g) | (g) |
| Example 1 | 90 | PCL | 60 | 100 | HEC | 10.0 | 140.0 |
| Example 2 | 90 | PCL | 60 | 100 | HEC | 5.0 | 145.0 |
| Example 3 | 90 | PCL | 60 | 100 | HEC | 3.8 | 146.3 |
| Example 4 | 90 | PCL | 60 | 100 | HEC | 2.5 | 147.5 |
| Example 5 | 90 | PCL | 60 | 100 | HEC | 15.0 | 135.0 |
| Example 6 | 90 | PCL | 60 | 100 | HEC | 20.0 | 130.0 |
| Example 7 | 90 | PCL | 60 | 100 | HMHEC | 10.0 | 140.0 |
| Example 8 | 90 | PCL | 60 | 100 | HMHEC | 5.0 | 145.0 |
| Example 9 | 90 | PCL | 60 | 100 | HMHEC + | 3.8 | 146.3 |
| | | | | | HEC | (HMHEC | |
| | | | | | | 1.9 g, | |
| | | | | | | HEC | |
| | | | | | | 1.9 g) | |
| Example 10 | 95 | PBAT(1) | 90 | 100 | HEC | 3.8 | 146.3 |
| Example 11 | 90 | PBA | 60 | 100 | HEC | 10.0 | 140.0 |
| Example 12 | 90 | PEA | 55 | 100 | HEC | 10.0 | 140.0 |
| Comparative | 90 | PCL | 60 | 100 | CMC | 10.0 | 140.0 |
| Example 1 | | | | | | | |
| Comparative | 90 | PCL | 60 | 100 | PVA | 10.0 | 140.0 |
| Example 2 | | | | | | | |
| Comparative | 90 | PCL | 60 | 100 | SPAN80 | 12.5 | 137.5 |
| Example 3 | | | | | | | |
| Comparative | 95 | PBAT(2) | 125 | 100 | HEC | 10.0 | 140.0 |
| Example 4 | | | | | | | |
| Comparative | 40 | PCL | 60 | 100 | HEC | 10.0 | 140.0 |
| Example 5 | | | | | | | |

PCL: Polycaprolactone (Ingevity)
PBAT(1): Polybutylene adipate terephthalate (ANKOR BIOPLASTICS) having a melting point of 90° C.
PBA: Polybutylene adipate (ANKOR BIOPLASTICS)
PBAT(2): Polybutylene adipate terephthalate (ANKOR BIOPLASTICS) having a melting point of 125° C.
HEC: Hydroxyethyl cellulose (Lotte Fine Chemical)
HMHEC: Hydrophobically modified hydroxyethyl cellulose (Lotte Fine Chemical)
CMC: Carboxymethyl cellulose (Lotte Fine Chemical)
PVA: Polyvinyl alcohol (Dongyang Steel Chemical: P-17S)
SPAN80: Sorbitan oleate (Sigma Aldrich)

### Experimental Example 1: Evaluation of Properties of Biodegradable Polymer Emulsion

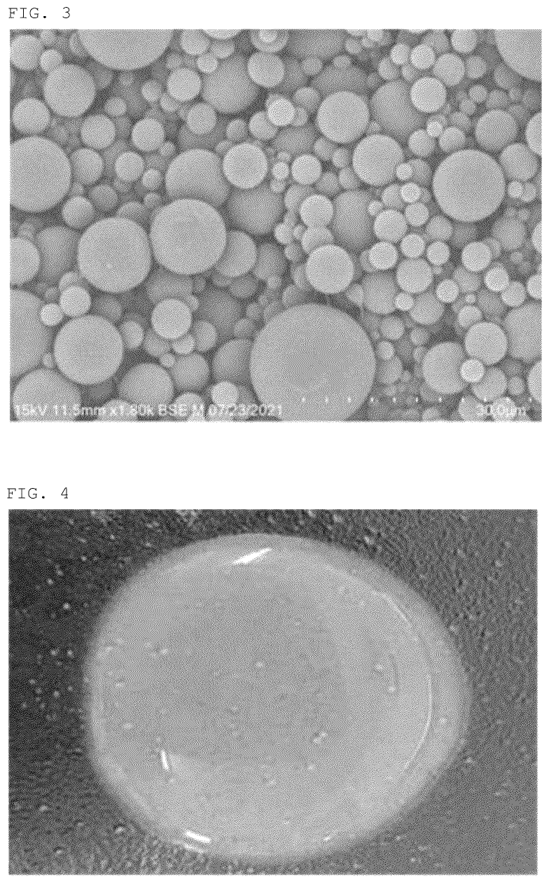

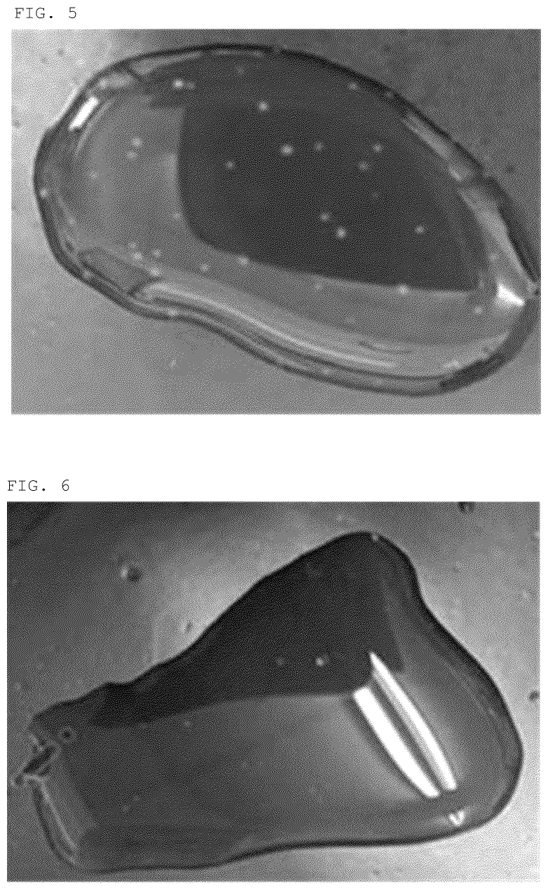

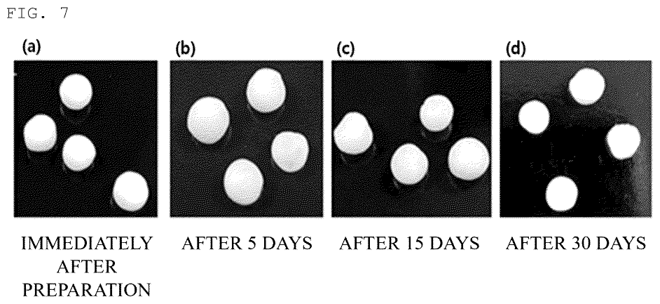

The physical properties of the biodegradable polymer emulsions prepared in Examples 1 to 12 and Comparative Examples 1 to 5 were measured by the following methods. The results thereof are shown in Tables 2 and 3 and FIGS. 2 to 6.

### (1) Measurement of Average Particle Diameter of Particles Dispersed

The average particle diameter of polymer particles dispersed in each biodegradable polymer emulsion was measured using the NANO-flex II device manufactured from Colloid Metrix. The results thereof are shown in Table 2.

### (2) Evaluation of Emulsion Condition

The emulsion condition was evaluated as “good” when the biodegradable polymer particles were uniformly dispersed in water while the average particle size thereof equal to or smaller than 150 μm accounted for 80% or more. Additionally, was evaluated as “poor” when the emulsion condition particle distribution was broader than that in the abovementioned case due to changes over time or when the particles failed to be normally dispersed. The results thereof are shown in Table 2.

### (3) Evaluation of Coating Condition

Each specimen was placed on a flat plate that held the prepared emulsion underneath the plate through vacuum suction. A coating film was formed to be 200 μm-thick and then dried for 30 minutes at a temperature equal to or higher than the melting point and glass transition temperature (Tg) of the biodegradable resin to form a coating. The coating condition was evaluated as “good” when uniformly formed. Additionally, the coating condition was evaluated as “poor” when stains or pinholes were formed or when the surface was uneven or flexural. The results thereof are shown in Table 2.

### (4) Evaluation of Water Resistance

Each specimen was placed on a flat plate that held the prepared emulsion underneath the plate through vacuum suction. A coating film was formed to be 200 μm-thick and then dried for one hour at a temperature equal to or higher than the melting point and glass transition temperature (Tg) of the biodegradable resin to form a coating. After weighing and dropping 10 g of water on the coating formed above, the water resistance was evaluated as “poor” when water seeped within one hour. Additionally, the water resistance was evaluated as “good” when there was no water seepage within one hour to 24 hours. The results thereof are shown in Table 2.

### (5) Evaluation of Fertilizer Release Properties

After spraying each biodegradable polymer emulsion, prepared in the examples and comparative examples, to a thickness of 100 μm onto 0.18 g of a fertilizer (Namhae Chemical, Super Allari Urea), the resulting product was dried at a temperature of 120° C. for 20 minutes to prepare a coated fertilizer, which was then deposited in 10 ml of distilled water, to measure the release amount of the fertilizer nitrogen content in the distilled water after 7, 15, and 30 days. The results thereof are shown in Table 3. The released nitrogen content measurements were analyzed using a Kjeldahl (VELP UDK 159) analyzer.

In this case, an uncoated fertilizer was measured as Experimental Example 5-1 to evaluate release sustainability. Additionally, the fertilizers coated each independently with the biodegradable polymer emulsions of the examples and comparative examples were measured as Experimental Examples 5-2 to 5-18. The fertilizer release properties were evaluated as “good”, “fair”, or “poor” when the release amount over 30 days was 2 mg or less, in the range of 2 mg to 4 mg, or 4 mg or more, respectively. The results thereof are shown in Table 3.

TABLE 2

| | Average | | | |
|---|---|---|---|---|
| | particle | Emulsion | Coating | Water |
| Classification | diameter (μm) | condition | condition | resistance |
| Example 1 | 8 | Good | Good | Good |
| Example 2 | 13 | Good | Good | Good |
| Example 3 | 18 | Good | Good | Good |
| Example 4 | 20 | Good | Good | Good |
| Example 5 | 10 | Good | Good | Good |
| Example 6 | 9 | Good | Good | Good |
| Example 7 | 10 | Good | Good | Good |
| Example 8 | 12 | Good | Good | Good |
| Example 9 | 12 | Good | Good | Good |
| Example 10 | 25 | Good | Good | Good |
| Example 11 | 12 | Good | Good | Good |
| Example 12 | 7 | Good | Good | Good |
| Comparative | 15 | Good | Poor | Good |
| Example 1 | | | | |
| Comparative | 18 | Good | Good | Poor |
| Example 2 | | | | |
| Comparative | Not | Poor | Poor | Poor |
| Example 3 | measurable | | | |
| Comparative | Not | Poor | Poor | Poor |
| Example 4 | measurable | | | |
| Comparative | Not | Poor | Poor | Poor |
| Example 5 | measurable | | | |

TABLE 3

| | Bio- | | | | |
|---|---|---|---|---|---|
| | degradable | Release amount of nitrogen | | | Fertilizer |
| | polymer | After 7 | After 15 | After 30 | release |
| Classification | emulsion | days | days | days | properties |
| Experiment 5-1 | — | 8.41 | 8.42 | 8.42 | Poor |
| Experiment 5-2 | Example 1 | 0.54 | 1.42 | 1.83 | Good |
| Experiment 5-3 | Example 2 | 0.47 | 1.23 | 1.71 | Good |
| Experiment 5-4 | Example 3 | 0.16 | 0.82 | 1.69 | Good |
| Experiment 5-5 | Example 4 | 0.25 | 0.91 | 1.78 | Good |
| Experiment 5-6 | Example 5 | 0.42 | 1.17 | 1.65 | Good |
| Experiment 5-7 | Example 6 | 0.63 | 1.58 | 1.91 | Good |
| Experiment 5-8 | Example 7 | 0.51 | 1.29 | 1.77 | Good |
| Experiment 5-9 | Example 8 | 0.61 | 1.55 | 1.74 | Good |
| Experiment 5-10 | Example 9 | 0.12 | 0.74 | 1.56 | Good |
| Experiment 5-11 | Example 10 | 0.35 | 1.24 | 1.89 | Good |
| Experiment 5-12 | Example 11 | 0.59 | 1.37 | 1.84 | Good |
| Experiment 5-13 | Example 12 | 0.61 | 1.31 | 1.92 | Good |
| Experiment 5-14 | Comparative | 2.54 | 3.22 | 3.65 | Fair |
| | Example 1 | | | | |
| Experiment 5-15 | Comparative | 5.67 | 7.81 | 8.32 | Poor |
| | Example 2 | | | | |
| Experiment 5-16 | Comparative | 3.07 | 4.11 | 4.90 | Poor |
| | Example 3 | | | | |
| Experiment 5-17 | Comparative | 7.82 | 8.21 | 8.22 | Poor |
| | Example 4 | | | | |
| Experiment 5-18 | Comparative | 7.52 | 7.90 | 8.18 | Poor |
| | Example 5 | | | | |

As shown in Tables 2 and 3 and FIGS. 2 to 7, it was seen that the emulsion condition, coating condition, water resistance, and release properties in the case of the biodegradable polymer emulsions prepared in Examples 1 to 12 were better than those in the case of the biodegradable polymer emulsions prepared in Comparative Examples 1 to 5.

Therefore, the biodegradable polymer emulsion, according to the present disclosure, is environmentally friendly because no organic waste liquid is generated in the preparation process, can prevent toxicity due to a residual organic solvent or emulsifier or deterioration in the physical properties of the biodegradable polymer, and improve the intrinsic physical properties of the biodegradable polymer, such as water resistance, confirming that the release rate of the fertilizer was controllable.

Although the limited embodiments and drawings of the present disclosure have been disclosed for illustrative purposes, the present disclosure is not limited thereby, and those skilled in the art will appreciate that various alternatives and modifications are possible, without departing from the scope and spirit of the present disclosure as disclosed in the accompanying claims.

1. A method of preparing a biodegradable polymer emulsion, the method comprising:
(a) mixing a biodegradable polymer, hydroxyethyl cellulose, and water to obtain a mixture;
(b) heating the resulting mixture to a temperature in a range of a melting point of the biodegradable polymer or higher to a boiling point of water or lower, with stirring; and
(c) cooling the heated and stirred mixture.

2. The method of claim 1, wherein the biodegradable polymer is a biodegradable polymer having a melting point that is equal to or lower than the boiling point of water.

3. The method of claim 1, wherein the biodegradable polymer is one or more selected from the group consisting of polybutylene adipate terephthalate (PBAT), polybutylene adipate (PBA), polybutylene succinate-adipate (PBSA), polybutylene succinate-terephthalate (PBST), polycaprolactone (PCL), and polyethylene adipate (PEA).

4. The method of claim 1, wherein the hydroxyethyl cellulose (HEC) is hydrophobically modified hydroxyethyl cellulose (HMHEC).

5. The method of claim 1, wherein in the (a) mixing, 1.0 to 20 parts by weight of hydroxyethyl cellulose and 60 to 500 parts by weight of water, with respect to 100 parts by weight of the biodegradable polymer, are mixed.

6. A biodegradable polymer emulsion comprising:
a biodegradable polymer;
1.0 to 20 parts by weight of hydroxyethyl cellulose with respect to 100 parts by weight of the biodegradable polymer; and
60 to 500 parts by weight of water with respect to 100 parts by weight of the biodegradable polymer,
wherein the biodegradable polymer has an average particle diameter in a range of 5 μm to 100 μm.

7. The emulsion of claim 6, wherein the biodegradable polymer is a biodegradable polymer having a melting point that is equal to or lower than a boiling point of water.

8. The emulsion of claim 6, wherein the biodegradable polymer is one or more selected from the group consisting of polybutylene adipate terephthalate (PBAT), polybutylene adipate (PBA), polybutylene succinate-adipate (PBSA), polybutylene succinate-terephthalate (PBST), polycaprolactone (PCL), and polyethylene adipate (PEA).

9. The emulsion of claim 6, wherein the hydroxyethyl cellulose (HEC) is hydrophobically modified hydroxyethyl cellulose (HMHEC).

10. A biodegradable polymer coating solution comprising:
a biodegradable polymer;
1.0 to 20 parts by weight of hydroxyethyl cellulose with respect to 100 parts by weight of the biodegradable polymer; and
60 to 500 parts by weight of water with respect to 100 parts by weight of the biodegradable polymer,
wherein the biodegradable polymer has an average particle diameter in a range of 5 μm to 100 μm.

11. The coating solution of claim 10, wherein the biodegradable polymer is a biodegradable polymer having a melting point that is equal to or lower than a boiling point of water.

12. The coating solution of claim 10, wherein the biodegradable polymer is one or more selected from the group consisting of polybutylene adipate terephthalate (PBAT), polybutylene adipate (PBA), polybutylene succinate-adipate (PBSA), polybutylene succinate-terephthalate (PBST), polycaprolactone (PCL), and polyethylene adipate (PEA).

13. The coating solution of claim 10, wherein the hydroxyethyl cellulose (HEC) is hydrophobically modified hydroxyethyl cellulose (HMHEC).
